(19) United States
(12) Patent Application Publication
(10) Pub. No.: US 2011/0228087 A1
(43) Pub. Date: Sep. 22, 2011

(54) Method for Manufacturing Black Plastic Article Capable of Transmitting Infrared Ray

(76) Inventor: Chi-Sheng HSIEH, Shanghai (CN)

(21) Appl. No.: 13/100,311

(22) Filed: May 4, 2011

Related U.S. Application Data
(63) Continuation-in-part of application No. 12/307,267, filed on Dec. 31, 2008, now abandoned.

(51) Int. Cl. H04N 7/18

(52) U.S. Cl. 348/143; 348/E07.085

(57) ABSTRACT

A method for manufacturing black plastic article capable of transmitting infrared ray, which includes mixing a black colorant, produced by mixing several transparent colorants of different color, into a transparent resin used as support, and processing the resulting mixture to manufacture a black plastic article. Said black plastic article is capable of absorbing visible light and transmitting infrared ray, and may be used in combination with an infrared region-sensitive CCD camera. The infrared region-sensitive CCD camera can take photos of the subject in a long distance through the black plastic article, if sufficient infrared ray from a subject may penetrate the black plastic article.

The Present invention is a continuation in part (CIP) of U.S. patent application with Ser. No. 12/307,267 assigned to the inventor of the present invention, which also the applicant of the present invention. Thereby, the content of the U.S. patent application with Ser. No. 12/307,267 is incorporated into the present invention as a part of the present invention.

### TECHNICAL FIELD

A invention relates to a kind of plastic which is capable of absorbing light and transmitting infrared ray, especially relates to a method for manufacturing a black plastic by mixing several colored transparent colorants into the colorless transparent resin and relates to an application in the infrared photograph thereof.

### BACKGROUND OF THE INVENTION

Generally, the black plastic article is mainly manufactured by mixing the inorganic black colorants into the opaque plastic using as support and then processing the resulting mixture. Most of said inorganic black colorants comprise the carbon black grains with a biggish diameter as a main part.

The carbon black grains exist as the original particles and always react into the polymer in the producing process. It is very difficult to diffuse said polymers due to the large inter-particle attraction therein, as a result that the light is blocked when transmitting through.

The smaller the diameter of the carbon black grains is, the bigger the specific surface area of the polymers is, as a result that more light will be absorbed to make the color thereof is seen blacker by the observer then that of the carbon black grains with bigger diameter, as the bigger grains will reflect more light. When using the carbon black as the colorant, the blackness mainly depends on the absorption of the light which happens in the interior of the carbon black grains, hence, for the carbon black with a certain concentration, the smaller the diameter is, the more absorption of the light is.

At present, the diameter of the original particulars of the common carbon black is about 100 nm, which is much smaller then the wavelength of the light which is 400 nm.

As the general black plastic articles use the carbon black grains with biggish diameter, the scattering therein and the functional group of —C—OH— on the surface thereon will effect the infrared absorption spectra between 800 nm and 1000 nm.

Besides, as the general black plastic articles use the opaque plastic as support, the scattering therein makes the infrared ray could not transmit through.

For example, mix of a kind of minuteness carbon black colorant in the market and the plastic to make a thin article. As said article could let a little light transmit through, the minuteness carbon black colorant used is called “transparent black colorant”. As said thin article could let a little light and infrared ray transmit through, it is always used in the infrared remote controls of the home electronic products. However, said thin article could only let the infrared pulse transmit through, but the infrared image. Even if the thin article could let the infrared image transmit through, the unclear image generated still could not be used in the infrared photography.

### SUMMARY OF THE INVENTION

One aspect of the invention is providing a black plastic article capable of transmitting infrared ray to resolve the problem that the black plastic article in the priority technology could not used in the infrared photography

The technical project of the invention is:

1. Mixing to get a black colorant:

Based on the optical principles, mix two or more than two colored transparent colorants together to get a black colorant, for example, mix the tricolor colorants, i.e., cyan, magenta and yellow together with a suitable proportion.

2. Manufacturing a black plastic article:

Mix said black colorant into a compatible transparent resin to form a black mixture. As the transparent resin is a material with plasticity, said black mixture could be molded into a plastic article with various shapes.

3. Manufacturing a suitable camera:

Remove the infrared cut filter in front of an infrared region-sensitive CCD camera, or install a device which could be removed with infrared cut filter in front of the image sensor, in order that when photograph through said black plastic article, the generation of the overlay images could be avoided then, which are formed by the visible light and the infrared, the infrared and the infrared.

The main features of the technical project are:

1. Said black colorant looks black, while it is capable of transmitting infrared ray.

Said black colorant could absorb the visible light spectrum including blue (B), red (R) and green (G), but the IR spectrum, i.e., it is capable of transmitting infrared ray.

2. Said black plastic article is a smooth-faced black plastic article manufactured by mixing the black colorant into a compatible transparent resin.

The transparent resin of the black plastic article should have high transparence with the order that said plastic article could be capable of transmitting infrared ray to generate the image for the infrared photograph.

Said transparent resin in the black plastic article is mainly used as support, which could be manufactured into a lot of plates, membranes and containers with various shapes and large bulks by the machines, the arts and crafts normally used in this technical field.

The surface of the black plastic article is smooth enough to avoid the scattering of the infrared ray transmitted into occurred by the rough surface, in order to generate clear infrared image for the infrared photograph.

3. In said infrared region-sensitive CCD camera, remove the infrared cut filter and add a special infrared pass filter, in order to let the infrared into image sensor and to avoid the excessive overlay images.

The technical effects of the adopted technical projects and features:

The first effect of this invention is that the easily got transparent colorants and the compatible transparent resin could be manufactured into a lot of plates, membranes, containers and other correlated products with large bulks and various shapes capable of transmitting infrared ray by the common plastic process equipments and the mature plastic pigmentation art techniques.

The second effect of this invention is that the said black plastic is too easy to transmit infrared ray, which makes an infrared region-sensitive CCD camera do transmittance photography to get a clear and not overlay image.

The third effect of this invention is that, because the said black plastic is capable of absorbing visible light, so it has the effect of darkroom and hide. In the application of propagation tests in the darkroom and public safety, an infrared region-sensitive CCD camera can be utilized to process a special function of multi-angle photograph and photograph surveillance.

### BRIEF DESCRIPTION OF THE DRAWINGS

The brief description of the drawings as follows:

FIG. 1 is a structure schematic diagram showing finished products of a black plastic, which is capable of transmitting infrared ray.

FIG. 1A is a schematic diagram showing the composition of the black colorant.

FIG. 1B is a schematic diagram of the metal mold.

FIG. 1C is an application schematic diagram of the black plastic article 15.

FIG. 2 is a tricolor map of the light.

FIG. 2A shows the energy sum of bicolor light.

FIG. 2B is a tricolor map of the colorant.

FIG. 3 shows a transparent thin plate M1 with the color of magenta.

FIG. 3A shows an opaque thin plate M12 with the color of magenta.

FIG. 4 is a diagram showing the overlay situation of the transparent thin plates with the colors of CMY tricolor.

FIG. 4A is a mathematics schematic diagram showing the CMY colorants and RGB lights.

FIG. 5 is a characteristic curve of the typical colors of the three receptors of human eyes.

FIG. 6 is a schematic diagram showing the cut filter of a common CCD color camera.

FIG. 6A is a schematic diagram showing the cut filter of a CCD color camera of a previous patent.

FIG. 6B is a schematic diagram showing the cut filter of the CCD color camera of the present invention.

FIG. 7 shows a plate 71 of a black plastic.

FIG. 8 is a schematic diagram showing the color photography of a black plate 71.

FIG. 8A is a schematic diagram showing the infrared photograph of a black plate 71.

FIG. 9 is a schematic diagram showing the infrared photograph of two different black plates.

FIG. 10 is a penetration schematic diagram of the cut filter of the CCD color camera of a previous patent.

FIG. 11 is a penetration schematic diagram of the cut filter of the CCD color camera of the present invention.

FIG. 12 is a schematic diagram showing the image generation situation of the infrared ray pass filter.

FIG. 13 is a cross-section diagram of a black colorant (carbon black).

FIG. 13A is a cross-section diagram of a black colorant 11.

FIG. 13B is a cross-section diagram of a thin black colorant (carbon black).

FIG. 13C is a cross-section diagram of a thin black colorant 11.

FIG. 14 is a schematic diagram of the observation darkroom of the propagation experiment.

FIG. 15 is a schematic diagram of the application in the counterfeiting identification.

### DETAILED DESCRIPTION

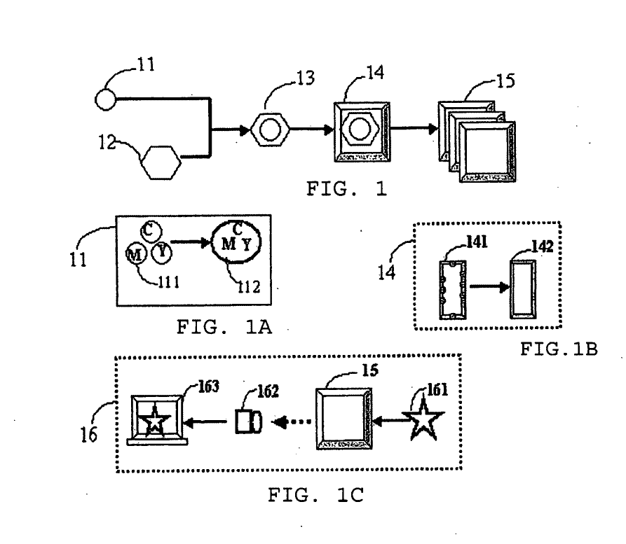

The primary principle structure contents of the invention are shown in FIG. 1 to FIG. 1C. Please refer to FIG. 1, the structure schematic diagram showing a black plastic, which is capable of transmitting infrared ray. In FIG. 1, mix said black colorant 11 and transparent resin 12 into a black mixture 13, and then mold said black mixture 13 with a metal mold 14 with a polished internal mold to form a black plastic article 15.

Please refer to FIG. 1A, the schematic diagram of black colorant composition.

In FIG. 1A, the composition method 111 of the black colorant 11 is to mix more than two kinds of unicolor transparent colorants 1111 together to present a black colorant 1112, mainly in order to present black and absorb the visible light.

Please refer to FIG. 1B, the conditional schematic diagram of the metal molds.

In FIG. 1B, the condition for the black plastic article 15 being injected into the metal mold 14 is that the internal mold 141 of the metal mold 14 must be polished. Wherein, the principal purpose is to let the injected black plastic article 15 have a smooth surface, so as to avoid the infrared ray transmitted into to be scattered on the rough surface.

Please refer to FIG. 1C, the application schematic diagram of black plastic article 15.

In FIG. 1C, there is an object 161 on the right side of the black plastic article 15, and an infrared region-sensitive infrared camera 162 on the left side. Said camera 162 could photograph the object 161 through the black plastic article 15 and transmit the image to the video display 163 of the infrared camera 162 to show.

Explain the embodiment of this invention according to FIG. 1.

Firstly, in the method for manufacturing the black colorant 11, why mix more than two kinds of the transparent colorants 1111 to compose a colorant 1112 which presents black? What is the purpose of mixing the transparent colorants to form the black colorant?

For example, FIG. 1A illustrates that cyan, magenta, yellow and other tricolor (hereinafter, CMY) colorant are mixed together with equal proportion to produce a mixture 1112. Then, use a compatible plastic as support to form the plastic articles of various colors. According to the experience of the experienced color matching technician or the referenced data, it is must be emphasized that the CMY colorants should not be mixed together with an equal proportion, because that will present gray black or black.

However, it is emphasized in this invention that, the three colorants with CMY colors must be mixed together with an equal proportion at the same time. Because, in this invention, the obtained mixture is mainly used to absorb all visible lights (not one hundred percents absorption).

Evidently, the method of this invention is different from that of the common plastic color matching process! This invention emphasizes that the CMY colorants used must be transparent!

Why the transparent tricolor CMY colorants should be used?

To let the infrared ray transmit through!

How to let the infrared ray transmit through? Details are listed as follows:

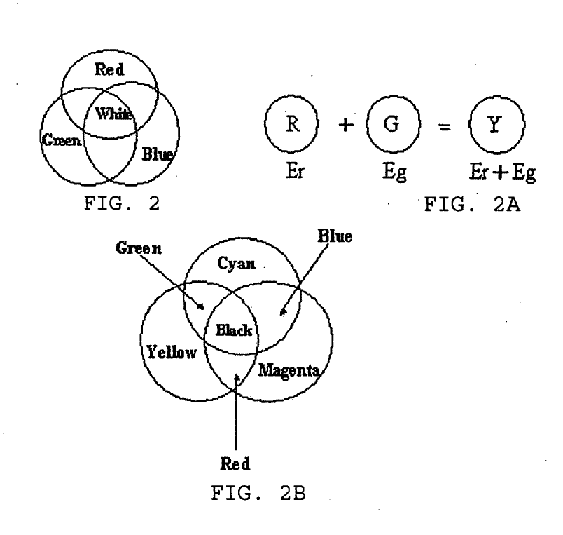

Please refer to FIG. 2, the tricolor map of the light.

As shown in FIG. 2, the tricolor of the light are respectively the red light with a main wavelength at 700 nm, the green light with a main wavelength at 520 nm and the blue light with a main wavelength at 460 nm, wherein the tricolor is named as RGB tricolor. In the optics field, all the visible lights are made up of the RGB tricolor light.

Please refer to FIG. 2A, the view showing an energy sum of the bicolor light.

When mixing the color lights to form a new color light, the energy of the new one is the sum of the energies of the mixed ones. As shown in FIG. 2A, mix a red light and a green light having the same exposure area. The exposure area of the obtained light is the same as that of the original light, while the energy of the obtained light is increased. That causes the brightness of the obtained light increase.

It can be observed in the color light mixture tests: white light can be obtained after equal mixing the tricolor light. If first mix red light and green light to get a yellow light, then mix the yellow light with blue light to get, a white light will also be obtained. A white light could also be obtained by mixing other color lights together. If after mixing two kinds of color lights, a white light is obtained, then these two kinds of color lights are called as the complementary color lights, and these two colors is called as the complementary colors.

One of the important characters of complementary colors is: one color light irradiates on an object of its complementary color, the color light will be absorbed. For example, a blue light irradiates on a yellow object, then the yellow object presents black.

Please refer to FIG. 2B, the tricolor map of the colorants.

The tricolors of the colorants are cyan, magenta, and yellow, abbreviated as CMY.

Color can be divided into two main categories, i.e., achromatic color and chromatic color. Achromatic color refers to white, black and gray-scale color made up of white and black.

Various kinds of objects have different colors under the light irradiation. The colors of many objects are provided with scrawl and dye of colorants. The materials, which are capable of making the colorless objects present color or making the colored objects change their colors, are called as the colorants.

The colorants have the solid shape and the liquid shape. The colorants can be divided into dyes, organic pigments and inorganic pigments.

Dyes are completely transparent and soluble in solvent without the spread problem.

The organic pigment has a particle diameter of about 0.05-0.1 .mu.m, is semi-transparent and unable to be soluble in solvent, and has low specific gravity. The inorganic pigment has a particle diameter of about 0.5-1 .mu.m, is opaque and completely unable to be soluble in solvent, has heavy specific gravity, and is lightfast and heat-resistant.

Generally speaking, the pigments are any kind of granule particle, while the dyes are small granules soluble in molecular conditions.

The colorants and the color lights are two different things, but they all have various colors. In the color lights, it is certain that the red light, the green light and the blue light are the basic original color lights. In many colorants, if there are several basic original colorants, which can not be obtained by mixing other colorants, but which can be mixed to form other colorants? It is found in the colorant mixture tests that when mixing the colorants with the tricolors of red, green and blue, just the same as those of the colored lights, although the color range of the obtained mixtures is not as broad as that of the mixtures of the colored lights, a lot of colorants still could be formed by mixing said colorants together.

But, for this invention, the main purpose of the color matching is to get a color most like the black. This invention does not care much about the special colors, how broad the color range is.

Learned from FIG. 2B, the black colorant 11 could be obtained by mixing the CMY tricolor colorants together or by mixing the RGB tricolor colorants together. Like the black in FIG. 2B.

Actually in FIG. 2B, mix two of the red, green and blur colorants equally, the obtained colorant still could absorb most part of the visible light to present black or other dark color.

Hence, for this invention, any approach which could by used to obtain said black shown in FIG. 2B could be deemed as the method for manufacturing the black colorant 11, whatever said black is composed by two colorants (for example, the green and the magenta) or by three colorants (for example, CMY colorants or RGB colorants).

From the perspective of energy, due to the energy loss, the color of the colorant mixture is certain to be darker then the pre-mixture color.

When mixing the colorants, it is always said that subtract a kind or several kinds of unicolor lights from the white light to make the colorant present another color (such method is also called as the subtractive color method).

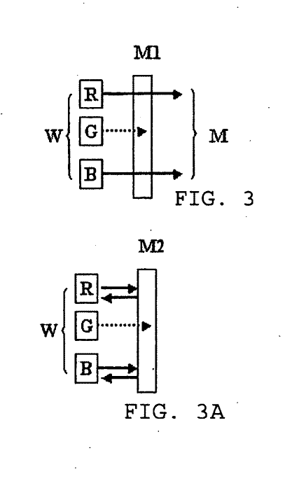

Please refer to FIG. 3, the thin color plate of transparent magenta.

As shown in FIG. 3, let the color light irradiate on an ideal, magenta, transparent and thin plate M1. According to the characters of the complementary color, the magenta thin plate M1 will absorb the G color light of the RGB color lights in the white light, and let the left R and B color lights transmit out. As shown in FIG. 2B, the magenta thin plate M1 presents transparently magenta.

Please refer to FIG. 3A, the thin color plate M2, which is magenta and opaque.

As shown in FIG. 3A, let the color light irradiate on a magenta, opaque and thin plate M2. Based on the reflection and absorption characters, the magenta thin plate M2 will absorb the G color light of the RGB color lights in the white light, and let the left R and B color lights reflect out. In the human eyes, the magenta thin plate M2 will present opaque and magenta after the reflection.

The above explains that, the transparent refers to the optical transmission phenomenon, and the opaque refers to the light reflection phenomenon.

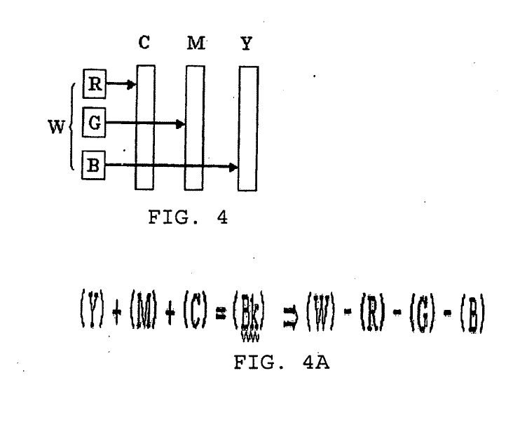

FIG. 4 is an overlay schematic diagram showing the transparent thin color plate of CMY tricolor.

When the white light W (containing the RGB tricolor lights) irradiates on the green, magenta, yellow, transparent thin plates, the green transparent thin plate C absorbs the R light in the white light W, the magenta transparent thin plate M absorbs the G light in the white light W, and the yellow transparent thin plate Y absorbs the B light in the white light W. In the end, the white light W is totally absorbed and becomes opaque and present black.

Please refer to FIG. 4A, the mathematics schematic diagram showing the CMY colorants and RGB color lights.

FIG. 4A illustrates that, after the equal mixing the three kinds of original colorants of green, magenta and yellow, the black colorant will be obtained, i.e., (C)+(M)+(Y)=(BK). That is, the black colorant explains the phenomenon that after the white light W (composed of RGB) absorbs RGB tricolor lights, it will present black.

After the equal mixing the tricolor colorants, the black color will be obtained, i.e., the formula could be written as (Y)+(M)+(C)=(BK).

Firstly, If mix the yellow and the magenta, the inter-red will be obtained, and then mix the inter-red with cyan, and the above formula may be changed into: (R)+(C)=(BK)

If after mixing two kinds of colorants, a black is obtained, then the said two kinds of colorants are called as complementary colorants, and the said colors are called as complementary colors.

That means, the black will be obtained by adding the red to the cyan, or by adding the cyan to the red. The red and the cyan are a couple of complementary colors. Besides, in the colorants, the magenta and the green, the yellow and the blue are respectively complementary colors.

Please note that, due to various proportion changes of tricolors, the complementary colors are more than the above couples.

As long as after the two kinds of colorants are mixed, the black is obtained, and the said two kinds of colorants are complementary colorants. Any kind of colorant has its counterpart complementary colorant.

The application of complementary colors is the main principal of the manufacturing method of the present embodiment.

Fox example, in the manufacture process, when a finished product need to be darkened (to be blacked) somewhere, it is no need to use black (carbon black), but adding a complementary color of its original color will do.

The additive color method is a method for presenting the color of the mixed color lights. After the color lights mixed, not only the color is different from each color lights took part in, but also the brightness is increased. The subtractive color method is a method for presenting the color of the mixed colorants. After the colorants mixed, not only the new color is generated, but also the brightness is decreased.

The additive color method is the color effects of more than two kinds of color lights stimulating the optic nerves of human being, while the subtractive color method is the color effects of the stimulation of some kinds of color lights which are subtracted from the white light or other polychromatic lights. There are basically three couples of complementary colors from the view of complementary relations, i.e., R-C, G-M and B-Y. In the additive color method of the color lights, the white light is obtained through the adding of complementary colors. In the subtractive color method of the colorants, the black light is obtained through the adding of complementary colors.

The tricolors of the color lights are red (R), green (G) and blue (B). The tricolors of the colorants are cyan (C), magenta (M) and yellow (Y). It is the color light that the people always see. It is certain that the tricolor of the colorants must be associated with the tricolor of the lights.

The cyan, the magenta and the yellow can easily change the absorbed capacity toward the red, the green and the blue by changing their own thickness (or density), and further successfully control the quantity of the tricolor lights entered into the human eyes.

To control reflection lights by using the cyan, the magenta and the yellow is actually to utilize them to selectively absorb some spectrum colors from light source spectrum, to accomplish adding mixture color effects with the left color lights. In the meantime, it is the selection and identification of the red, green and blue of the color light tricolor. The red, the green and the blue of the color light tricolors are uniform with the cyan, the magenta and the yellow of the colorant tricolors, and they have common natures, and they are the two sides of an object. It is certain that they all get bigger color range. In a word, it is the color lights that entered into the human eyes.

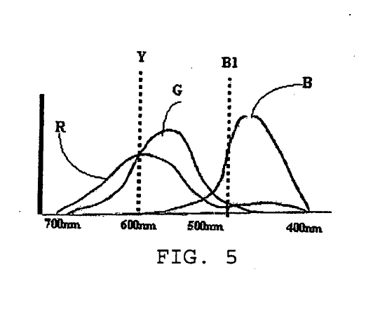

Please refer to FIG. 5, the typical color characteristic curve showing three receptors of human being.

As shown in FIG. 5, the reception of color-receiving cells of human being toward the red, the green and the blue are respectively the red light area, the green light area and the blue light area.

When the eyes receive different quantity of colors, the feelings toward the colors are determined by the bigger color light among the three kinds of color lights. The receiving-sensitive are showed in the coordinate axis, wherein, the Y-axis representing the sensitiveness of the optic nerves of human being, the X-axis representing the visible wavelength table.

As shown in FIG. 5, the wavelength of 400 nm could make the eyes receive the blue B and the red R receptors at the same time. As a result, an average color feeling is felt in the eyes, and that is the purple. With the wavelength increasing, the reception quantity of the blue receptor increases gradually, so the feeling toward purple is replaced by the blue. When the wavelength reaches 480 nm, as the equal quantity of red and green are received together with part of the blue, then the white is generated. Meanwhile as another part of blue left, so the pure blue B1 is received in the end. Due to the disappearing white light generated by the unequal quantity of the red light, the green light and the blue light, the feeling toward the blue is the decreasing purity (saturation) blue. When the wavelength continues to reach 600 nm, the reception towards the red light and the green light is strong, while the blue light is attenuated, so the reception towards the yellow and the green is received. Reaching to 600 nm, the reception towards the blue light is hardly received, only the equal red R and green G, and the reception towards yellow Y are received. When the wavelength continues to reach 700 nm from 600 nm, the reception towards the red light and the green light is attenuated gradually, while the reception towards green is evident, and the yellow light with the red light is received by the eyes. When the wavelength reaches 700 nm, only the red light is basically received.

So, the general colorants are not the single tinge.

The long wave after the red light in the visible light is the infrared area, and in the present embodiment, it refers to the area from 780 nm to 1000 nm, which is the effective wavelength received by the Image Sensor of the CCD camera, and the light there is normally called as the infrared ray.

Well known in the industry chromatics, if mix a colorant with another colorant and the mixture presents black, these two colorants are called as the complementary colors.

But in the transparent complementary colorants, the mixture color differs greatly. For example, the transparent yellow+the transparent blue=the emerald green, the transparent red+the transparent yellow=the bright orange, the transparent blue+the transparent red=the bright purple. Evidently, no black presented.

From the energy perspective above, the light energy decreases after the colorants are mixed, then the mixture color is certain darker than the original color. If the density (dosage) of the transparent colorant is not enough or too tenuous, the light energy decreases little after the colorants mixed. Increasing the density to let the light energy decrease to a certain extent, the similar black will be obtained.

As mentioned above, that is the reason why the transparent tricolor CMY is used.

Simply, the “transparent” of the transparent tricolor CMY colorants is mainly to let the infrared ray transmit through. The mixture of the transparent tricolor CMY colorants is mainly to absorb the visible lights and present black.

The following explains the transparent resin 12.

The transparent resin 12 must be highly transparent, so the surface thereof must have perfect quality that there are no stripes, no pores, no drifting white, no fog areola, no black spots, no color change, no poor gloss and so on.

There is commonly minute surface in the transparent polymer and that makes light scattering happen, and the typical example is the crystal structure. For example, water and ice are both made up of H.sub.2O. Generally, water is transparent, but ice is opaque. The reason is that ice has a crystal structure and it makes the light scattering happen, which let the light transmit through decreasingly, and water is otherwise. So, non-crystal structure is one of the factors to be transparent.

In industrial plastic, the well transparent resins are PMMA (transparent degree 93%), PC (transparent degree 88%), PS (transparent degree 89%), CR-39 (transparent degree 90%), SAN resin (transparent degree 90%), MS resin (transparent degree 90%), TPX (transparent degree>90%). Besides, MAS, PET, PP and PVC and so on, they all have good transparent degree. As long as a compatible transparent plastic or generally transparent colorants are found, the need of capable of transmitting infrared ray is reached in the present embodiment.

In the above said generally transparent resin 12, the transmittance of the light not only includes the visible lights with the wavelength from 380 nm to 780 nm, but also actually covers up the near infrared area with the wavelength from 780 nm-1200 nm.

The transparent quality of the visible lights and the infrared ray in the polymer is generally influenced by the reflection, absorption, and scattering of the lights.

When the lights reach the polymer, a part of the lights is expensed on the surface due to the reflection. When the light vertically incident from the air with a refractive index n1 (n1=1) into a polymer with a refractive index n2, the surface eflectivity R could be presented as R=(n−1).sup.2/(n+1).sup.2. The data shows that, the refractive index of the transparent acryl PMMA (organic glass) is 1.49, and the calculation surface reflection R is about 4%. The entire light transmittance of PMMA is about 93%, and the loss of the light is mainly due to the surface reflection, but the absorption and scattering inside is very minor.

When the light reaches the polymer molecule, the molecule will absorb its energy and generate whirligig, which generate light absorption and decrease light transmittance. The scattering at the same time will also decrease light transmittance heavily.

The intrinsic scattering of the polymer is in direct proportion to the 8.sup.th power of the refractive index, and is inversely proportional to the 4.sup.th power of the wavelength. Therefore, the loss of material scattering is less in the less refractive index, and the effect on scattering in the visible area with long wavelength is less. The effect on scattering in the infrared area with long wavelength is less almost to zero. This is very important for the embodiment of the present invention.

Furthermore, the impurity which are generated or administrated in the process of the manufactures will decrease the light transmittance because of the scattering. The data of the manufacture factory shows that, the impurity in the optical level PMMA is only one of the tenth of the general molding level PMMA, and this is why the present embodiment suggests using the optical level PMMA. In the practical application, the light transmittance is largely influenced by the fluctuation of the environment temperature and the humidity. Generally speaking, the bigger refractive index of the high molecular polymer is, the bigger the reflectivity is. The uneven configuration of the high molecular polymer makes the microcosmic refractive index uneven optically, and a phenomenon of scattering happens. The refractive index of optical level is very even.

At present, the transparency of the acryl PMMA (methyl methacrylate) is second to none in the transparent plastics, and an object can be seen through, even when the molding board is 2 m. It has the quality that it can be pigmented by the dyes freely, very good surface gloss, and no harm to human being.

Spectroscopic light transmittance of the PMMA made by the Rayon of the Japanese Mitsubishi Corporation is increasing near the ultraviolet light at 250 nm and totally not absorbed in the visible light area. The PMMA resin on the market always has agents against ultraviolet light. The range of spectroscopic light transmittance in infrared ray is from 800 nm to 1600 nm.

First, choose PMMA to do the experiment. PMMA is a kind of amorphous plastic, the high polymer of which arranges in disorder and has no well-regulated arrangement configuration formed, in the process of solidification of which there is no development of crystal nucleus and grain. The PMMA only has the phenomenon of the high polymer chain being frozen. So they are mostly transparent. All amorphous plastic polymers have good light transmittance and lower density. In the crystalline polymers, as the reflections of the spherocrystal and the vagiform regions are different, the crystalline polymers has bad light transmittance and high material density, that means the crystalline polymers are not suitable to the present invention.

The PMMA acryl boards have good process performance and could be used either in the heat molding (including mold press, blow mold, vacuum absorbing mold) or in the machine process including the drill, lathing, the incision and so on are adopted. The machine scratch and engraving controlled by the microcomputer not only largely increase process precision, but also work out the design and the modeling, which can not be accomplished by the traditional way. Furthermore, adhesion, painting, metal deposition, dyeing and so on, can also be done, and it is very adaptable to the present invention.

The following explains the black plastic article 15.

The present embodiment actually refers to the technique of plastic matching colors. The added colored colorant must not affect the light transmittance of the PMMA resin itself. So the “transparent” colorants must be used, and the reflection of every colorant does not differ much from that of the resin, so as not to decrease the light transmittance of the resin.

The water absorption capacity ratio of the general PMMA at room temperature under 100% relative humidity is about 2%, but the permissible dosage of the injection molding material is beyond 0.1%, so the factories always prepare dryness before the molding, in order to get rid of water.

In the usual injection molding process, the black mixture material 13 is supplied to the heating jar through a funnel, wherein, which is heated and dissolved, and then pressed into the metal mold 14 through the orifice by the ejection pressure, wherein, to fill the mother mold through the gate and the runner. And it can be taken out after cooling.

The current art on the PMMA coloring process is very mature. The coloring work of the present embodiment is done by the professional factories, so the manufacture process will not be illustrated.

In the present embodiment, hand over the colorant lists of the transparent tricolor colorants of cyan, magenta, and yellow to the professional factories to choose. The professional factories select the transparent colored colorants of some special brands and mix said colorants with the proportion of one of the third each, and then add a small amount of the dispersant. Stir the obtained mixture in the mixer to get the powder black colorant 11.

And then the transparent granules 12 of optical level PMMA and the powder black colorant 11 are stirred in the mixer to get the granules 13 of the black mixture materials. Wherein, the proportion between the transparent granules 12 of PMMA and the powder black colorant 11 is 100 to 0.4. (if use other less transparent resins, the proportion may be about 100 to 0.2).

In the present embodiment, hand over a prepared metal mold 14 to a plastic factory to manufacture a finished product which will be used in the experiment later. The internal mold of the metal mold must be polished precisely, in order to make the black plastic 15 have a very smooth surface plane that the scattering of the incident infrared ray due to the non-smooth surface could be avoided.

The alternative resin in the application of the present embodiment is PC (Polycarbonate), and its transparency is a little worse than that of the PMMA (about 92%).

The differences between them as follow:

The shortcomings of PMMA: higher water absorption, less heat resistance, can't bear the impact well, easy to light-off.

The shortcomings of PC: poor formability.

Because of higher viscosity of PC, its forming temperature is also higher. But it does not require particularly difficult forming techniques. The benzene ring in the molecular structure of PC is asymmetrical in the three-dimension, so the amorphous have good transparency, and the light transmittance in the visible light area is up to 90%. In addition, PC is also difficult to be ignited (also known as the fire rating).

In the high-performance transparent resin invented for the CD-ROM, its molecular structure is characterized as the ester ring. It has the same characteristics of birefringence with that of PMMA, but its water absorption is much lower than that of PC, about 1%. Other representative transparent resins are APO developed by the Japanese Mitsui Chemicals with a light transmittance up to 90%, ZEON developed by the Japanese ZEONEX with a light transmittance up to 91%, ARTON developed by the Japanese Synthetic Rubber Company with a light transmittance up to 92%.

As the PC materials have hygroscopicity, the drying before the processing is very important.

In the injection molding, as the mixture of PC and the black colorant 11 has a higher viscosity than that of the PMMA, the forming temperature should be higher. However, it does not particularly require difficult molding technology. It can be formed in accordance with the specifications provided by the manufacturer, or be produced by OEM manufacturers.

So, again, the inventor hand over a prepared metal mold 14 with precisely polished internal mold to a plastic factory to manufacture a finished product to be used in the experiment.

To learn more about the black plastic article 15, as well as its application, the present embodiment designs a color camera, which could take the clear color image and the clear infrared image respectively in the visible light area and in the infrared ray area. Especially, such camera could be used in the infrared transmittance photography to avoid the overlay of the visible image and the infrared image.

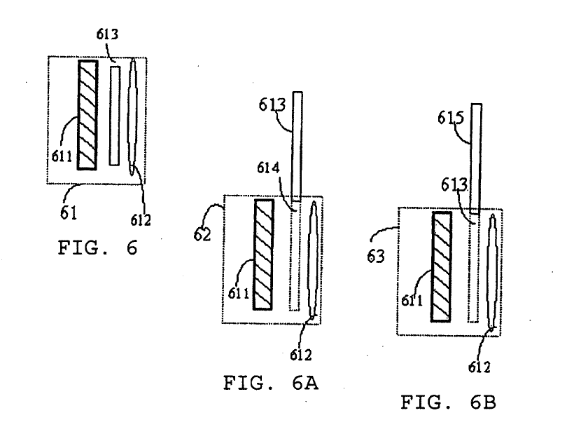

Please refer to FIG. 6, the schematic diagram 61 showing a common CCD color camera filter.

FIG. 6A is a schematic diagram 62 showing a previous patent CCD color camera filter. FIG. 6B is a schematic diagram 63 showing the present embodiment CCD color camera filter.

FIG. 6 is a schematic diagram 61 showing a common CCD color camera filter, including the image sensor 611 (including quartz glass), the photographic lens 612 and the infrared ray cut filter 613. When the visible light enters into the image sensor 611 from the lens 612, only the visible light is accessible, and the infrared ray will be cut off. When the infrared ray in the visible light is mainly filtered, the true color images can be obtained (not the reddish color).

Wherein, FIG. 6A is a schematic diagram 62 showing a CCD color camera filter of a previous patent, which includes the image sensor 611, the photographic lens 612, the infrared ray cut filter 613 and the colorless transparent glass 614.

When the visible light enters into the image sensor 611 from the lens 612, if the infrared ray cut filter has been installed on, only the visible light is accessible, and the infrared ray will be cut-off. Then the true color images can be obtained.

The visible light could transmit through whatever there is transparent quartz glass or not. The installed transparent quartz glass is used to replace the vacant position to avoid the difference in the optical path.

When the infrared ray cut filter 613 is removed, the camera of FIG. 6A has almost the same functions as those of the general black-and-white camera, which means it could sense the visible light and the infrared ray at the same time.

FIG. 6B is a diagram 63 of the cut filter of the CCD color camera mentioned in the embodiment of this invention, wherein the camera includes an image sensor 611, a photographic lens 612, an infrared ray cut filter 613 and an infrared ray pass filter 615. When the visible light transmits into the image sensor 611 through the photographic lens 612, if the infrared ray pass filter is installed, then only the infrared ray could pass, while the visible light and other infrared ray will be cut off. And then if the infrared ray cut filter is installed, then only the visible light could pass, while the infrared ray will be cut off.

Hence, the differences are listed as follows with the reference of FIG. 6 to FIG. 6B:

The device of FIG. 6 has a fixed infrared ray cut filter 613, while the device of FIG. 6A has a removable infrared ray cut filter 613.

The device of FIG. 6B has a removable infrared ray cut filter 613 and a removable infrared ray pass filter 615.

### Embodiment 1

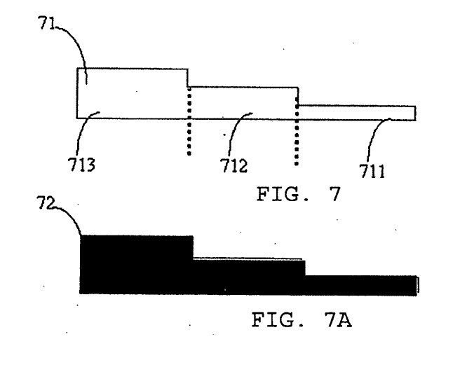

Please refer to FIG. 7 which shows a plate 710 of a black plastic article.

The plate 71 is made of a black colorant 11 obtained by mixing the optical level transparent colorant of CMY together with an equal proportion. Mix said black colorant 11 into the optical level transparent resin PMMA 12, and then mold the obtained mixture with a metal mold to get the black plate 71 used in the experiment.

As shown in FIG. 7, the black plate 71 has a smooth surface which has three step-thick blocks, wherein the thickness of the blocks 711, 712 and 713 are respectively 1 mm, 2 mm and 3 mm.

Now, handing the prepared black plate 71 closely to the eyes and then observing the lamp across the black plate 71, it could be found that the lamp is presented blue, purple-like, brown-like respectively observed through the blocks 711, 712 and 713. If the amount of the black colorant 11 is increased, said colors will be changed approaching to the black. Hereby, the color of the black plate 71 is named as the similar color of the black.

The black plate 71 manufactured by this method is mainly used to absorb the visible light. It does not focus on the how dense the concentrations of the black is, which degree the absorption is, while it focuses on the black plate is opaque to the human eyes in order to achieve the opaque effect.

If put a deep blue transparent plate onto a bottom the main color of which is black, the deep blue transparent plate is seen as black by human eyes. That indicates that the visible light transmits through the deep blue transparent plate and the black color seen by human eyes is reflected from the black bottom.

In order to explain the difference between the transmittance of the visible light and that of the infrared ray, mix the black color masterbatch (carbon black) used in the common plastic instead of the black colorant 11, together with the optical level transparent resin PMMA, and then mold the obtained mixture with the metal mold used before to get a pure black plate 72 with the same bulk.

It is necessary to prove that the black plate 71 manufactured by the method of this invention has different phenomenon of light transmittance from the pure black plate 72 with the common inorganic black colorant.

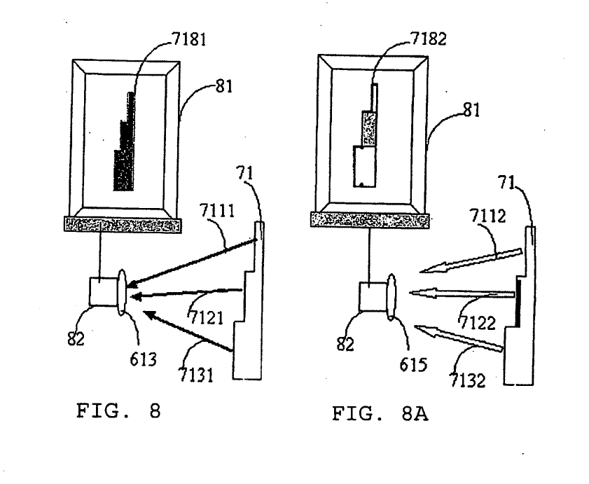

Please refer to FIG. 8, the schematic diagram showing the color photography of the black plate 71.

The device of FIG. 8 includes a video display 81, a color camera 82 and a black plate 71.

When the infrared ray cut filter 613 is installed onto the color camera 82, only the visible light could transmit through, while the infrared ray is cut off and could not pass through.

The visible light transmit through the black plate 71 and then into the color camera 82, wherein the visible light includes the lights 7111, 7121 and 7131 which are through the blocks 711, 712 and 713 respectively. And the lights are transported to the video display 81 after entering to the color camera 82, and then all generate the visible light image 7181 of the plate 71.

When the infrared ray pass filter 615 is installed onto the color camera 82, only the infrared ray could transmit through, while the visible is cut off and could not pass through.

Please refer to FIG. 8A, the schematic diagram showing the infrared photograph of the black plate 71.

Sandpaper the surface of the middle block 712 of the black plate 71 to process the smooth surface into the rough surface. Meanwhile, keep the surfaces of the other two blocks 711 and 713 smooth.

The infrared ray transmit through the black plate 71 and then into the color camera 82 to be transported to the video display 81 thereafter, wherein the infrared ray includes the rays 7111, 7121 and 7131 which are through the blocks 711, 712 and 713 respectively. The generated image of the middle block 712 is an opaque white infrared image, while those of the side blocks 711 and 713 are both transparent infrared images.

The middle block 712 of the black plate 71 presents an opaque white infrared image mainly due to the reason that the rough and not smooth surface thereof will cause the incident infrared ray scattered on the surface. Here, the scattering is also called as diffuse reflection. And as the infrared ray has already been scattered, it could not transmit through or will not have enough throughput to generate an infrared image.

That means it is necessary to polish the internal mold of the metal mold 14 used to mold the black plate 71, so as to obtain a black plate 71 with smooth surface. That is the key to let the infrared ray transmit through.

Besides, as there are two different media (air and plate 71), the refractions in the two media make the transparent image of the plate 71 presents a plate 71 with clearly outline around after being transmitted into the color camera and transported to the video display 81. The infrared image 7182 of the transparent plate 71 could be seen in said outline

That means, if pattern the plate 71 purposely to form rough words or design on the surface thereof, after the image of the plate 71 has been transported by the color camera 82 to the video display 81, such image presents the opaque and clear words and design.

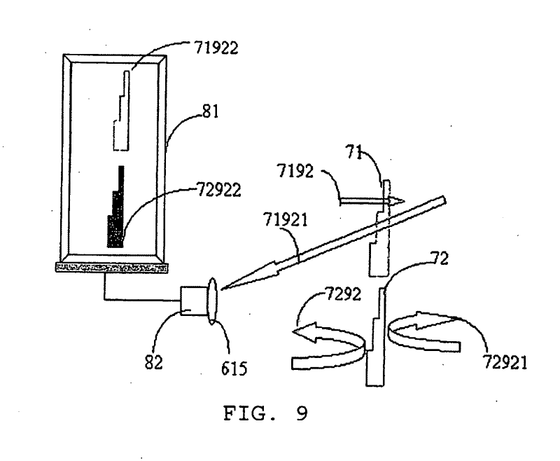

Please refer to FIG. 9, the schematic diagram showing the infrared photograph of two different black plates.

The device of FIG. 9 includes a black plate 71, a pure black plate 72, a color camera 82 and a video display 81.

When the infrared ray pass filter 615 is installed onto the color camera 82, only the infrared ray could transmit through, while the visible light is cut off and could not pass through.

In the incident infrared ray transmitted through the black plate 71, most part of the infrared ray 7192 on the same side of the color camera 82 has disappeared when transmitting through the black plate 71, i.e., has not entered into the lens of the color camera 82. On the opposite side of the color camera 82, i.e., the back region of the black plate 71, the infrared ray 71921 transmits through the black plate 71 and enters into the color camera 82 to generate an infrared image 71922 of said black plate 71 on the video display 81.

In the incident infrared ray transmitted through the pure black plate 72, most part of the infrared ray 7292 on the same side of the color camera 82 has reflected on the surface of the pure black plate 72 and entered into the color camera 82, then generated a transparent infrared image 72922 of said pure black plate 72 on the video display 81. On the opposite side of the color camera 82, another part of the infrared ray 72921 has disappeared after being reflected on the surface of the pure black plate 72, i.e., has not entered into the lens of the color camera 82.

Hence, on the video display 81, there are the transparent infrared image 71922 of the black plate 71 (just like a transparent glass) and the opaque white infrared image 72922 of the pure black plate 72 (just like an opaque black glass).

The light is selective absorbed by the objects, which is the main reason for the color of objects. In some opinions, the red opaque plate 16 is red because of the irradiation of the white light, and the red opaque plate 16 has no color itself. It is the light that is the source of the color. If the red surface is irradiated with the green light, it will present black, because the radiation in the wavelength of the green light is totally absorbed. If the red surface is irradiated with the infrared ray, it will present colorless (non-color), because the red surface only reflects the red light, and as the infrared ray has no red light to be reflected, the red surface will has no color. Hence, the object will present different color under the irradiations of the different components of the spectrum of visible light. But if the object is irradiated by the infrared ray, which is composed of the red spectrum, the object will present colorless. 19

If the infrared energy of the color camera is too little to generate a clear infrared image, an assisted infrared light source could be used to irradiate the objects (the plate 71 and 72) directly or indirectly to increase the environmental infrared energy.

When mentioning the cut filter in the color camera 82, what is the difference between the cut filter 62 of the previous patent in FIG. 6A and the cut filter 63 of this invention in FIG. 6B?

In order to explain the difference between FIG. 6A and FIG. 6B and to satisfy the practical application, it is necessary to use a large black plate.

The casting method and the extrusion method are normally used in manufacturing the large PMMA black plate. The US company Swedlow researched in the method of continuously producing the transparent PMMA plate with the metal mold made of stainless steel. Such method has already been granted for patent (U.S. Pat. No. 3,376,371), but it is unsuitable for producing the thick plate.

In the casting method, two large inorganic glasses are used as mold with a close pad, such as the soft vinyl chloride, inset along the periphery of two large inorganic glasses. The material of the close pad should be insoluble in the polymer paste made of PMMA and the transparent colored color masterbatch, should be harmless to the polymer material. Even if the polymerization is completed, the close pad should not break away. And along the polymerization of the paste, the volume contracts and the close pad has the ability to be squashed. Hence, the hardness and the shape of the close pad must be suitable, or the produced large PMMA black plate will have irregular concave, or the paste will leak out in the polymerization.

Heat the mold with the paste inside either in the air bath or the water bath for about five hours under 70.degree. C. to make the polymer be solidified. The first finished product has air bubbles inside. As the polymerization heat could not be removed in time, the polymer paste is in the state of boiling that the bubbles are generated. This situation will be improved if the polymerization time is extended and the polymerization temperature is reduced. The two ends of the two large inorganic glasses are clamped by a clip.

As mentioned before, the inventor of this invention entrusted a colorant manufacture company to produce the black colorant by mixing the optical level transparent liquid colorants with the CMY tricolor together, and then entrusted a PMMA plastic manufacture factory to product a large black plate by casting. Such large black plate is used in the application experiment.

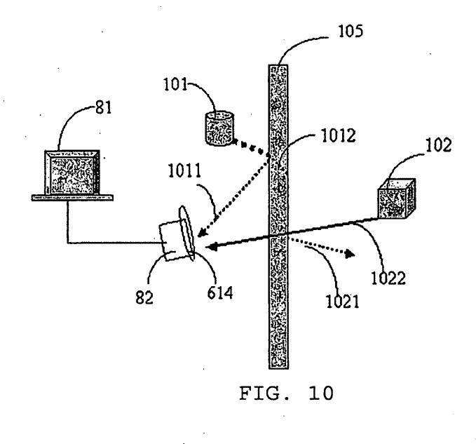

Please refer to FIG. 10, the penetration schematic diagram of the cut filter of the CCD color camera of a previous patent.

The device of FIG. 10 contains a color camera 82, a video display 81, a large black PMMA plate 105, an object 101 and an object 102, wherein, the color camera 82 has a transparent glass 614. The object 101 and the object 102 are placed on both sides of the large black plate 105.

Here, as the color camera has a transparent glass 614 on, both the visible light and the infrared ray could transmit into the lens of the color camera 82.

As the visible light image 1011 of the object 101 could not transmit through the black plate 105, the surface of the black plate 105 reflects said image into the color camera 82 to present a visible light image of the object 101 on the video display 81.

As the infrared image 1012 of the object 101 could transmitted through the black plate 105, said image could not enter into the color camera 82. As a result, no infrared image of the object 101 is presented on the video display 81.

As the visible light image 1021 of the object 102 could not transmit through the black plate 105, the surface of the black plate 105 reflects said image back. Hence, said image could not enter into the color camera 82. As a result, no visible image is presented on the video display 81.

As the infrared image 1022 of the object 102 could transmit through the black plate 105 and then enter into the color camera 82, the infrared image of the object 102 is presented on the video display 81.

As a result, the visible image of the object 101 could be seen on the video display 81, meanwhile the infrared image of the object 101 could also be seen. That means the two images overlap.

Of course, if the environmental visible light of the object 101 is very strong (for example, there is an assisted white light source), the visible image of the object 101 will cover the infrared image of the object 102, and only the visible image (colored image) of the object 101 could be seen on the video display 81.

On the contrary, if the environmental infrared ray of the object 102 is very strong (for example, there is an assisted infrared ray source), the infrared image of the object 102 will cover the visible image of the object 101, and only the infrared image (black-and-white image) of the object 102 could be seen on the video display 81.

If the object 101 and the object 102 are placed in the same environment, for example in the sunlight from the outside which almost has enough visible light and infrared ray to be provided for generating the images in the color camera 82. Here, it could be seen on the video display 81 that the two images of the object 101 and the object 102 are overlapped.

In order to reduce the overlap of the two images, this invention hereby makes an improvement that replaces the transparent glass 614 with an infrared ray pass filter 615.

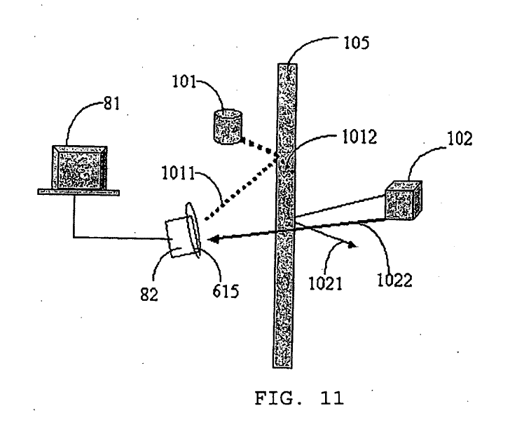

Please refer to FIG. 11, the penetration schematic diagram of the cut filter of the CCD color camera of the present invention.

As shown in FIG. 11, the infrared ray pass filter 615 could only let the infrared ray transmit through, but not the visible light.

That means, the visible light image 1011 of the object 101 reflects on the surface of the black plate 105, and then will be stopped by the infrared ray pass filter 615 before it reaches the color camera 82. Hence, no visible light image could be generated then. At the same time, the infrared image 1012 of the object 101 transmits through the black plate 105. So the infrared image 1012 of the object 101 could not reach the color camera 82 for the image generation.

As a result, the image of the object 101 can no be seen on the video display 81.

As the visible image 1021 of the object 102 is reflected on the surface of the black plate 105, it could not enter into the color camera 82 for the generation of the image. While the infrared image 1022 of the object 102 transmits through the black plate 105, so it could reach the color camera 82 for the image generation.

As a result, the image of the object 102 can be seen on the video display 81.

In this way, the comprehensive result is that, the overlap images of the object 101 and the object 102 can not be seen. Furthermore, the transmittance function emphasized in this invention is carried out.

The overlap images of the object 101 and the object 102 can be seen on the video display 81, one is the visible light image of the object 101, and the other is the infrared ray image of the object 102. When the infrared ray pass filter 615 is added, the visible light image of the object 101 is cut, so the overlapping images are reduced.

However, if the object 101 is in the infrared ray environment, (or the infrared ray is greater than the visible light), do the two overlapping images of the object 101 and the object 102 can be seen?

The answer is uncertain!

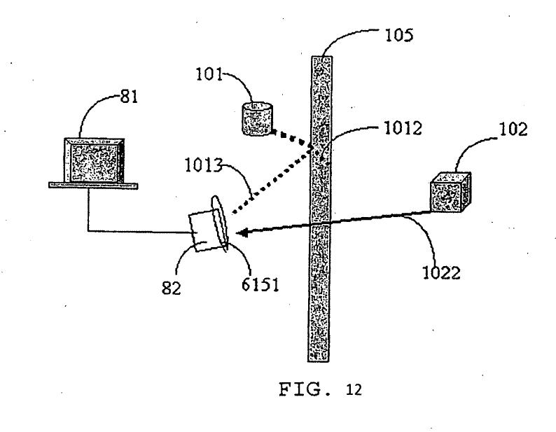

Please refer to FIG. 12, the schematic diagram showing the image generation situation of the infrared ray pass filter.

First of all, if the object 101 is in the infrared ray environment (with the middle wavelength of 850 nm), and the wavelength of the cut infrared ray filter 6151 is 940 nm, that is to say, the infrared ray with the wavelength before 940 nm will be cut off, and only the infrared ray with wavelength after 940 nm will transmits through.

So, the infrared ray image 1013 at 850 nm of the object 101 can not reach the color camera 82 for the generation of the infrared ray image of the object 101 on the video display 81.

In fact, a little of the infrared ray image 1013 at 850 nm of the object 10 will be reflected on the black plate 105, and most part of the infrared ray image 1012 will transmit through the black plate 105.

Also, if the object 101 is in the infrared ray environment (with the middle wavelength 850 nm), and the cut infrared ray filter 6151 is also 850 nm, and then, the two overlapping images of the infrared image 1013 of the object 101 and the infrared image 1022 of the object 102 can be seen again. The method to reduce the two overlapping images is to change the infrared pass filter 615 into the infrared cut filter 6151, which is to make the wavelength of the infrared ray pass filter bigger than the wavelength of the infrared ray (850 nm) environment wherein the object 101 is.

In this embodiment, the obvious effect will occur when an assisted infrared ray source with the same wavelength of the cut filter 6151 is added into the environment of the object 102. And the infrared ray images 1022 at 940 nm are enhanced and powerful enough to successfully reach the color camera 82 and present a very clear image.

Here, this infrared ray pass filter 6151 which could cut the infrared ray of certain wavelength, is called as the infrared ray pass filter 615 with cut function.

When the light meets the color particle, the direction of the light will be changed, and this phenomenon is called the scattering. The changed angles are correlative with the size of the color particle and the relative refractive index between the color particle and the medium.

The following will explain the concept of “transparent” and “opaque” with the scattering phenomenon. The black plastic article 15 of the present embodiment is opaque for the visible lights and is transparent for the infrared ray.

First of all, the “transparent” and “opaque” of the visible light will be explained.

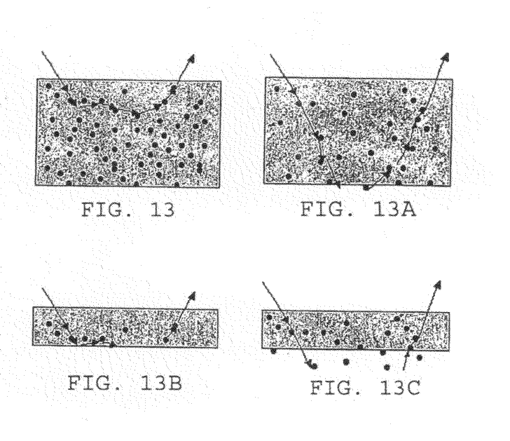

Please refer to FIG. 13, the cross-section diagram of a black colorant (carbon black).

FIG. 13 is a cross-section of the carbon black, wherein, when the visible lights enter into the internal carbon black particles of carbon black (black spots in the drawing), most of which are absorbed, and fewer are scattered by the diffraction around the carbon blacks. Due to the excessive consumption of the light energy, the visible lights can not enter into the deep and transmit through, and present opaque at last.

Please refer to FIG. 13A, the cross-section diagram of a plastic article 15.

The FIG. 13A illustrates that, the visible lights enter into the internal particles of the black plastic articles, (black spots in the drawing), most part is absorbed, and fewer are diffracted around the particle. This is because the colorants and the resins of the black plastic articles are transparent. The drawing shows that, the black spots are scare and the distribution is loose, wherein, a minute of visible lights transmit through and present a little transparent. For example, the black plate 105 looks a little blue.

Please refer to FIG. 13B, the cross-section diagram of a black colorant (carbon black).

FIG. 13B is a thin (with a relatively fewer black articles) cross-section of the carbon black, wherein, when the visible lights enter into the internal carbon black particles of carbon black, most part is absorbed, and fewer is diffracted around the carbon black particles (diffraction is one kind of scattering) and then transmits out through the membrane interface. A minute of visible lights transmit through and present a little transparent.

Please refer to FIG. 13, the cross-section diagram of a plastic article 15.

The device of FIG. 13C is a black plastic article 15, wherein, when the visible lights enter into the internal particles of the black plastic article 15, one part is absorbed, and the other part is diffracted around the particles. Most of the visible lights transmit through and present a little more transparent.

As shown in FIG. 13, the incident lights of the three carbon blacks are scattered in clouds of the carbon black particles and do not have enough energy to transmit into the deep, so it present opaque. But as shown in FIG. 13A to FIG. 13C, the incident lights of three carbon blacks are scattered in loose carbon black particles and have slightly enough energy to transmit into the deep, and a minute of visible lights transmit through and present a little transparent.

Secondly, the “transparent” and “opaque” of the infrared ray will be explained.

The scatterings of fine particles follow the Rayleigh scattering Law: the intensity of the scattering lights is negatively related to the four square of the wavelength. The wavelength of the blue light is comparably short and is easily to be scattered, while the red light is not the case. The occurring scattering when the size of the common colorant fine particles is smaller than one of the tenth of the wavelength of the visible light is called the Rayleigh scattering. So the fine particles always show Rayleigh scattering.

According to the Rayleigh scattering Law, compared with the visible light, the scattering of the infrared ray is very small, because the wavelength of the infrared ray is longer than that of the color light.

So, if there is a minute of visible light transmitting through the device of FIG. 13A to FIG. 13C, it must present transparent in the infrared ray.

As shown in FIG. 13, as the wavelength of the infrared ray is longer than that of the visible light, the infrared ray has not enough energy to enter into the deep and then to transmit through. So the infrared ray presents opaque in the colorant carbon black.

If the device of FIG. 13A is a black plastic article, then most of the incident visible lights are absorbed, and the black plastic present opaque in the visible lights. However, a small amount of visible light transmits through, and it is not easy to be seen without the strong light (or a special light source) background. This case is mentioned above, and can be accepted for the present embodiment. So it is also called to present opaque in the visible lights.

Wherefore, the black plastic article 15 presents opaque in the visible lights, but transparent in the infrared ray. The color camera 82 as shown from FIG. 8 to FIG. 12, when it carries out photography on the visible lights or the infrared ray, the impact point of the focus will be different, so there is a need to readjust the focal length.

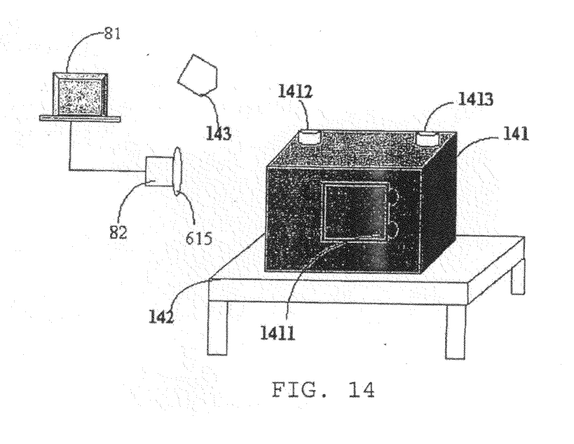

To prove the utility of this invention, please refer to the FIG. 14 which is the diagram of the animals and plants observation darkroom.

In FIG. 14, there are a color camera 82, a video display 81, an observation darkroom 141 made of the black plastic article 15 used in the animals and plants experiments, a table 142 with the observation darkroom 141 thereon, an assisted infrared light source 143. On the observation darkroom 141, there is a door 1411, a ventilation device 1412 and an exhaust device 1413. The desktop of the table 142 is a transparent glass plate.

When it is necessary to observe the experimental changes of an animal or a plant in the dark and no light condition, the observation darkroom of this invention could be adopted together with the color camera 82 with an infrared ray pass filter 615 inside, an assisted infrared light source 143 and a video display 81 to achieve a better effect.

For example:

1. During the observation period, the door 1411 could not be opened to satisfy the need of observation by eyes, because the light transmitted into from the open door will affect the experiment.

2. If is necessary to observe and record the development and the change of a special period, or a long time of observation and recording, or a condition of continuous moment change.

For example, a little white mouse that has taken special drugs is put into the observation darkroom 141 through the door 1411, and the growth and action of the mouse are observed in the dark. The air convection is provided by the ventilation device 1412 and an exhaust device 1413. As people can not open the door 1411 for the observations with eyes, the use of the color camera 82 been installed an infrared ray filter 615 on, is freely moveable from the exterior of the observation darkroom, in order to find a suitable observation point of view for the transmittance photography monitoring and observation.

When the animals (white mice) in the observation darkroom run around, the color camera 82 and the assisted infrared ray source 143 through the video display 81 can be freely moved by the experiment staff, until the right position can be found to carry out the observation and photograph being taken.

If necessary, observe the abdomen after the animals lie down from a piece of transparent glass of the desk 142, and the photographs can be taken.

The growth process of a special plant in the darkroom can be observed from the observation darkroom, or the photosynthesis and the record of growth phenomenon in the particularly built-in light source can be observed.

In addition, in the public safety equipments, such as suspicious objects placed in the trash and temporary leave-box in tenor areas, the infrared photography can also be used to carry out long-range detection.

The observation darkroom 141 used in animals and plant tests presents opaque in the visible lights, but presents transparent in the infrared ray.

That explains one of the application values of black plastic articles.

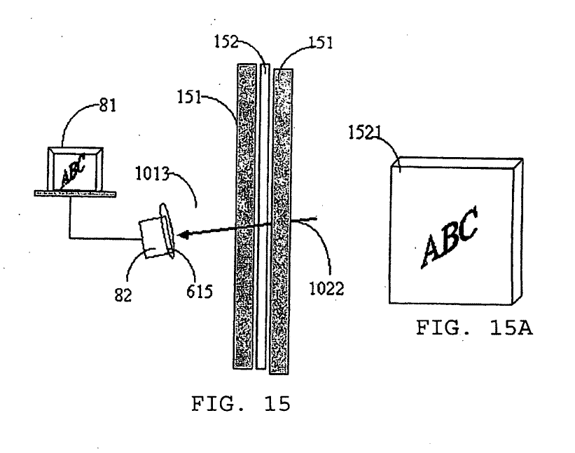

Please refer to FIG. 15, the schematic diagram of the application in the hiding identification.

In FIG. 15, a transparent colorless plastic plate 152 is inserted into the middle area between two black plastic plates 151. Write the words “ABC” with a black color pen on the surface of the transparent colorless plastic 152. As shown in FIG. 15A, the transparent colorless plastic 1521 has the pattern of text on.

Under this situation, when the infrared ray pass filter 615 is installed on into the inside of the color camera 82:

it could be seen on the video display 81 that there are three words “ABC” hided inside of the black plastic plates 151.

This sandwich structure could be used together with the transmittance photography of the color camera 82 in the anti-counterfeiting surveillance field.

Of course, there are other applications of this sandwich structure. For example, attach or cave some patterns of text on the surfaces of some of a plurality of black plastic plates 151, then use the color camera 82 photographs these black plastic plates 151. The image of the photograph on the video display 81 is an infrared image with more hierarchical structure.

In the previous technology, the black colorant (carbon black) could not let the infrared ray transmit through due to the scattering of the black colorant (the particles of the carbon black are too large) and the scattering of the opaque resin (the energy of the infrared ray is not enough).

That means if we want to improve the black colorant (carbon black) of the previous technology which could not let the infrared ray transmit through, the main method is using the grinded black colorant sold on the market (the particles of this black colorant is smaller enough to reduce scattering thereon) and the transparent resin to achieve the ideal situation.

Hence, the inventor bought the grinded black colorant (commonly known as the transparent black, hereinafter, the transparent black) to replace the three transparent colorants with CMY colors. Then entrust the plastic produce factory to mix this transparent black into the compatible PMMA to mold another black plate. Use this new black plate to do the experiment shown in FIG. 8 and FIG. 8A again. It is found that the new black plate has the same infrared transmission effect as that of the black plate 151.

Obviously, the qualities of the transparent black of the different manufacturers are different that a number of experiments must be taken to obtain a better processing method. The smaller the particles of the transparent black are, the better absorption of the visible light there are. But, as shown in FIG. 13 to FIG. 13C, in the same unit, if the particles are too small, the density of the particles will reduced relatively, which will let too much visible light pass through. As known, the less the visible light pass, the more opaque human eyes feel.

To sum up the results of the experiments above:

A method for manufacturing black plastic article capable of transmitting infrared ray mainly is mixing the transparent colored colorant and the transparent colorless resin together to obtain a mixture which will be processed by machines thereafter. The obtained products are able to absorb the visible light and let the infrared ray transmit through. This manufacturing method includes three steps:

Step 1: mix the transparent colored colorant together to compose the black colorant 11;

Step 2: mix the black colorant 11 into the transparent resin with a proportion to compose the black mixture material 13;

Step 3: process the obtained black mixture material 14 by molding with the mold having a polished internal mold, casting with two plates with smooth surfaces or by other mechanical methods.

Please refer to FIG. 2B of the step 1. Mix two colorants (for example, the colorants with complementary colors) together and stir the obtained mixture to compose a transparent colorant with similar black color, wherein the colorants mixed are colored by the transparent colorants with CMY tricolor.

In the step 1 above, the colored (black) transparent colorant is a grinded black colorant that the diameter of the particles after the grinding is one of the tenth of the original diameter before the grinding. Said grinded black colorant is used to reduce the scattering thereon.

In the step 1 above, the colored (black) transparent colorant is processed by the nano-treatment method to reduce the scattering thereon. The processed particles might be too small that its low density will let too much visible light pass through, just as shown in FIG. 13A to FIG. 13C. This situation is contrary to the purpose of this invention that the visible light is stopped.

In order to avoid the products are too transparent to the visible light, other transparent colored colorants could be used together. After a few times of the experiments, it is found that when the general black colorant after being grinded has a particle diameter smaller than the wavelength of the visible light, a satisfied infrared image will be obtained in the experiment, just like that of FIG. 8A.

The transparent colored colorant could be a solid, a liquid, a plasm or a paste. As long as such transparent colorants could be mixed to compose a mixture with similar black color, the purpose of this invention is achieved.

Therefore, in the step 1, the black colorant is composed of the transparent colored colorants.

In the step 2, mix the black colorant with the compatible transparent resin with a proportion of 0.4 to 100. Actually, such proportion could be adjusted according to the need, if only an acceptable infrared image could be generated finally. Such proportion is not limited to the 0.4 to 100.

In the step 2, the transparent resin 12 is an industrial resin with the best transparency, the transparence of which is about 88% or above. It is very important that in such transparent resin 12, its light transmittance not only includes the visible light with a wavelength from 380 nm to 780 nm, but also includes the near-infrared field with a wavelength from 780 nm to 1200 nm actually.

For example, there are PMMA (transparence 93%), PC (transparence 88%) and other transparent resins. Any resin could be used only if it is compatible to the transparent colorants.

In the step 3 above, the black mixture material is mainly processed by the mechanical methods of injection mold, pressing, casting and so on, just like the normal molding process.

In the molding process of the black mixture material 13, a metal mold with a polished internal mold or other assistant appliances must be used to manufacture the products with smooth surfaces and various shapes.

The manufactured black plastic article 15 capable of transmitting infrared ray is mainly used with a color camera 82, the image sensor of which has an infrared ray cut filter 6151 in front. In the transmittance photography, such color camera 82 is mainly used to reduce the overlap of the image, so as to get a clear object.

Such color camera 82 could be replaced by normal black-and-white camera.

When using the black-and-white camera (sensitive to the infrared ray), if there is interference in the taking the infrared image, an assisted infrared light source could be used to increase the energy of the infrared ray over that of the visible light. Hereby, the interference of the visible light could be reduced and the overlap of the visible image and the infrared image could also be avoided.

In practice, based on the application in the observation darkroom shown in FIG. 14, the application in the counterfeiting identification field shown in FIG. 15, it could be known that this invention could be used in a wide field and it also could be further used based on the original uses.

1. A surveillance device (100) comprising:
A camera (20) having at least one lens (10), and a black plastic sheet (30) having smooth surface, capable of penetration of the infrared ray, is set on the front of the camera (10);
Said black plastic sheet (30) is made by mixing a black plastic article (11) and a transparent resin (12);
The black plastic (11) is a black pigment with particles thereof processed by a grind process to have diameter smaller than a wavelength of visible light.

2. The surveillance camera of claim 1, wherein the black colorant is composed of a transparent colorant and is prepared by mixing and stirring transparent colorants with the color of cyan, magenta and yellow.

3. The surveillance camera of claim 1 wherein the black colorant is composed of transparent colorants and is prepared by mixing transparent colorants together, wherein the colorants are compatible with each other and makes all the complementary colors of black colorant, including the colorants with the transparent tricolor of cyan, magenta and yellow.

4. The surveillance camera of claim 1 wherein the black colorant is composed of transparent colorants and is prepared by mixing and stirring transparent colorants with color of red, green, and blue.

5. The surveillance camera of claim 1 wherein the black colorant is composed of the transparent colorants and is prepared by mixing transparent colorants together, wherein the colorants are compatible with each other and makes all the complementary colors of black colorant, including the colorants with the transparent tricolor of red, green, and blue.

6. The surveillance camera of claim 1 wherein the transparent resin is acryl PMMA, polycarbonates resin PC, other transparent resin compatible with the black colorant.

7. The surveillance camera of claim 1 wherein the black colorant is mixed into the transparent resin with a proportion of 0.4 to 100 to form a mixture which is used directly thereafter, or is processed into sticks and then cut into grain to form a black master batch by machines or equipments.

8. The surveillance camera of claim 1 wherein the camera is selected from a camera having a detachable infrared ray cut filter, a camera without an infrared ray cut filter, a camera having a movable infrared ray pass filter and an infrared ray cut filter set therein, and a camera having a movable infrared ray pass filter and an infrared ray cut filter provided on an exterior.

9. The method of claim 1 wherein the surveillance camera (100) includes further an infrared ray projecting device (40).
